(19) United States
(12) Patent Application Publication
(10) Pub. No.: US 2012/0072374 A1
(43) Pub. Date: Mar. 22, 2012

(54) RECORDING AND TRANSCRIPTION SYSTEMS

(75) Inventors: Derrill P. Williams, Phoenix, AZ (US); Henry Hickling, Leederville (AU)

(73) Assignee: FTR PTY LTD, Perth (AU)

(21) Appl. No.: 12/888,283

(22) Filed: Sep. 22, 2010

(51) Int. Cl. G06F 17/00

(52) U.S. Cl. 705/400

(57) ABSTRACT

Computer systems facilitating requesting recordings and/or transcriptions of proceedings including computer-implemented price estimation for recording transcription services.

### CROSS-REFERENCE TO RELATED APPLICATION

The present application is related to and claims priority from prior provisional patent application Ser. No. 61/024,855, filed Jun. 22, 2009, entitled “THERECORD ONLINE”, the contents of which are incorporated herein by this reference and are not admitted to be prior art with respect to the present invention by the mention in this cross-reference section.

### BACKGROUND

This invention relates to recording and transcription management computer systems. In legal and legal-related proceedings, maintaining the record is a crucial job. The testimony of a witness or the statements of an accused made during a police interrogation, if not properly preserved, can lead a judge or jury to make a wrong decision. Without the benefit of a court reporter, it becomes necessary to transcribe a recorded proceeding to have a text version of the proceeding. Several parties are involved in preserving the record of a proceeding: the court, the court-appointed person designated to control recording equipment used to document the proceeding, court administrators, court clerks, transcription agencies, typists, etc. Because the relationships of attorneys, courts, transcription agencies, etc., is complicated, systems are needed which assist providing access to recorded proceedings for future use.

### SUMMARY OF THE INVENTION

In accordance with a preferred embodiment hereof, this invention provides a computer-implemented method, relating to transcription generation from at least one recorded proceeding, such method comprising the steps of: determining, by at least one computer, elapsed time of at least one recorded proceeding; retrieving, by at least one computer, stored rate information for transcription generation; and generating, by at least one computer, at least one price estimate to generate at least one transcript of the at least one recorded proceeding by calculating the product of the determined elapsed time and the stored rate information. Moreover, it provides such a computer-implemented method further comprising the step of displaying at least one generated price estimate for approval by at least one requestor. Additionally, it provides such a computer-implemented method further comprising the step of receiving requestor approval to produce at least one transcript of the at least one recorded proceeding. Also, it provides such a computer-implemented method further comprising the step of providing requestor access to the at least one produced transcript. In addition, it provides such a computer-implemented method wherein, prior to determining, by at least one computer, elapsed time of at least one recorded proceeding, at least one portion of the recorded proceeding is selected. And, it provides such a computer-implemented method wherein at least one recorded proceeding is loaded into at least one recording playback device and such at least one recording playback device permits selection of at least one start time and at least one end time from which elapsed time of the selected timeline may be determined by at least one computer. Further, it provides such a computer-implemented method wherein the stored rate information for transcription generation includes at least one price per page and at least one average page per hour rate.

In accordance with another preferred embodiment hereof, this invention provides a computer-implemented method, relating to transcription generation from at least one recorded proceeding, such method comprising the steps of: receiving at least one request for at least one transcript of at least one recorded proceeding; receiving at least one copy of the at least one recorded proceeding; generating at least one price estimate for transcription preparation of the at least recorded proceeding; receiving approval to prepare at least one transcript; receiving at least one completed transcript. Even further, it provides such a computer-implemented method further comprising the step of receiving at least one computer-assisted selection of at least one transcription agency to manage transcript preparation. Moreover, it provides such a computer-implemented method further comprising the step of receiving at least one computer-assisted selection assisting selection of at least one typist to perform transcript preparation. Additionally, it provides such a computer-implemented method further comprising receiving at least one log sheet associated with the at least one recorded proceeding. Also, it provides such a computer-implemented method wherein the at least one recorded proceeding is found and selected from a plurality of recorded proceedings using at least one interface to assist finding a particular recorded proceeding recorded at a particular location. In addition, it provides such a computer-implemented method wherein the at least one recorded proceeding is found and selected from a plurality of recorded proceedings using at least one interface to assist finding a particular recorded proceeding recorded on a particular date. And, it provides such a computer-implemented method wherein the at least one recorded proceeding is found and selected from a plurality of recorded proceedings using at least one interface to assist finding a particular recorded proceeding recorded at a particular time. Further, it provides such a computer-implemented method further comprising the step of providing access to at least one entitled user to at least one recording and at least one generated transcript corresponding to the at least one recording. Even further, it provides such a computer-implemented method further comprising the step of providing access to at least one entitled user to at least one recording, at least one corresponding log sheet, and at least one generated transcript corresponding to the at least one recording. Moreover, it provides such a computer-implemented method wherein the at least one recorded proceeding is found and selected from a plurality of recorded proceedings using at least one interface to assist finding particular information corresponding to information found in at least one log sheet. Additionally, it provides such a computer-implemented method further comprising receiving time information corresponding to the time of the recorded proceeding. Also, it provides such a computer-implemented method wherein the time information is used to generate the at least one price estimate for transcription preparation of the at least recorded proceeding.

In accordance with another preferred embodiment hereof, this invention provides a computer-implemented method comprising the steps of: loading at least one digitally recorded proceeding into at least one playback device; selecting, with the assistance of at least one computer, at least one start time and at least one end time of such at least one digitally recorded proceeding; determining, by at least one computer, at least one time value corresponding to the amount of time between the at least one start time and the at least one end time; storing the determined at least one time value to assist transcription of the at least one digitally recorded proceeding. In addition, it provides such a computer-implemented method further comprising generating at least one price estimate for transcription of the at least one digitally recorded proceeding proportional to the determined at least one time value.

In accordance with another preferred embodiment hereof, this invention provides a computer-implemented method, relating to transcription generation from at least one recorded proceeding, such method comprising the steps of: determining, by at least one computer, elapsed time of at least one recorded proceeding; retrieving, by at least one computer, stored rate information for transcription generation; and generating, by at least one computer, at least one price estimate to generate at least one transcript of the at least one recorded proceeding by calculating the product of the determined elapsed time and the stored rate information.

In accordance with another preferred embodiment hereof, this invention provides a computer-implemented method, relating to providing access to at least one recorded proceeding, such method comprising the steps of: receiving from at least one requestor at least one request for at least one copy of at least one recorded proceeding; receiving at least one copy of the at least one recorded proceeding requested by way of transmission over at least one network; and providing the at least one requestor with access to the at least one copy of the at least one recorded proceeding requested.

In accordance with another preferred embodiment hereof, this invention provides a computer-implemented method, relating to providing access to at least one recorded proceeding, such method comprising the steps of: receiving at least one request for at least one recorded proceeding; receiving at least one copy of the at least one recorded proceeding; generating at least one price estimate for accessing the at least recorded proceeding; receiving approval to provide the at least one recorded proceeding; receiving the at least one recorded proceeding.

Lastly, this invention provides each and every novel feature, element, combination, step and/or method disclosed or suggested herein.

### BRIEF DESCRIPTION OF THE DRAWINGS

FIG. 1 shows a diagram illustrating a preferred computer communication environment used in preferred embodiments of the present invention.

FIG. 2 shows a diagram illustrating a computer environment used in preferred embodiments of the present invention.

FIG. 3 shows a flowchart illustrating a method of fulfilling a request for a recording or transcript of a recording according to a preferred embodiment of the present invention.

FIG. 4 shows a diagram illustrating the interactions of various user types with the computer system elements hereof.

FIG. 5 shows a diagram illustrating computer interactions among various computer elements of recording and transcription management system according to a preferred embodiment of the present invention.

FIG. 6 shows an illustration of a log in screen of a recording and transcription management web site according to a preferred embodiment of the present invention.

FIG. 7 shows illustrations of various computer interface screen of a recording and transcription management web site illustrating an order request process according to a preferred embodiment of the present invention.

FIG. 8 shows an illustration of order request information displayed by recording and transcription management web site according to a preferred embodiment of the present invention.

FIG. 9A shows an illustration of a portion of an order fulfillment process according to a preferred embodiment of the present invention.

FIG. 9B shows a set price interface of recording and transcription management web site according to a preferred embodiment of the present invention.

FIG. 10 shows an illustration of another portion of an order fulfillment process according to a preferred embodiment of the present invention.

FIG. 11 shows an illustration of an interface after successful uploading of a recording or log sheet according to a preferred embodiment of the present invention.

FIG. 12 shows a price estimation process for producing a transcript from a recorded proceeding according to a preferred embodiment of the present invention.

FIG. 13 shows an assign transcription agency process according to a preferred embodiment of the present invention.

FIG. 14 shows an assign typist process according to a preferred embodiment of the present invention.

### DETAILED DESCRIPTION OF THE BEST MODES AND PREFERRED EMBODIMENTS OF THE INVENTION

In some courtrooms, proceedings are recorded for preservation of a record of the proceeding. Government agencies, including law enforcement agencies, record various types of proceedings for preservation purposes. The recorded proceedings may contain audio and/or video information.

The computer systems described herein assist in making the recorded proceedings usable for review and other uses. The systems described herein also assist in making it easier for courts and transcription agencies to manage requests for copies of recordings of proceedings and transcription of those recorded proceedings.

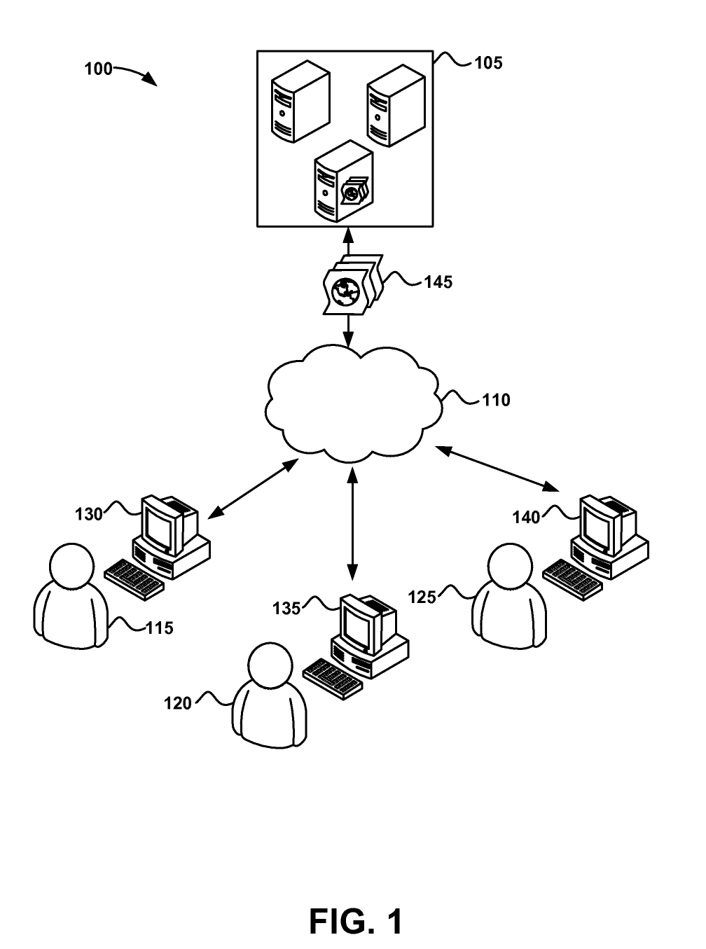

FIG. 1 shows a diagram illustrating a preferred computer communication environment used in preferred embodiments of the present invention. FIG. 1 shows communication components of recording and transcription management system 100. Recording and transcription management system 100 preferably comprises recording and transcription management computer system 105, as shown. As shown in FIG. 1, users (user 115, user 120, and user 125, which represent any number of users) preferably communicate with recording and transcription management computer system 105 using computers (computer 130, computer 135, and computer 140) over network 110. Network may either be a local area network (LAN) or a wide area network (WAN). Network 110 is most preferably the Internet.

Recording and transcription management computer system 105 preferably comprises one or more computer systems having at least one input device, at least one output device, at least one memory, and at least one computer processor. Recording and transcription management computer system 105 preferably is configured to serve recording and transcription management web site 145, as shown. Users (user 115, user 120, and user 125) preferably interact with web pages of recording and transcription management web site 145 over network 110.

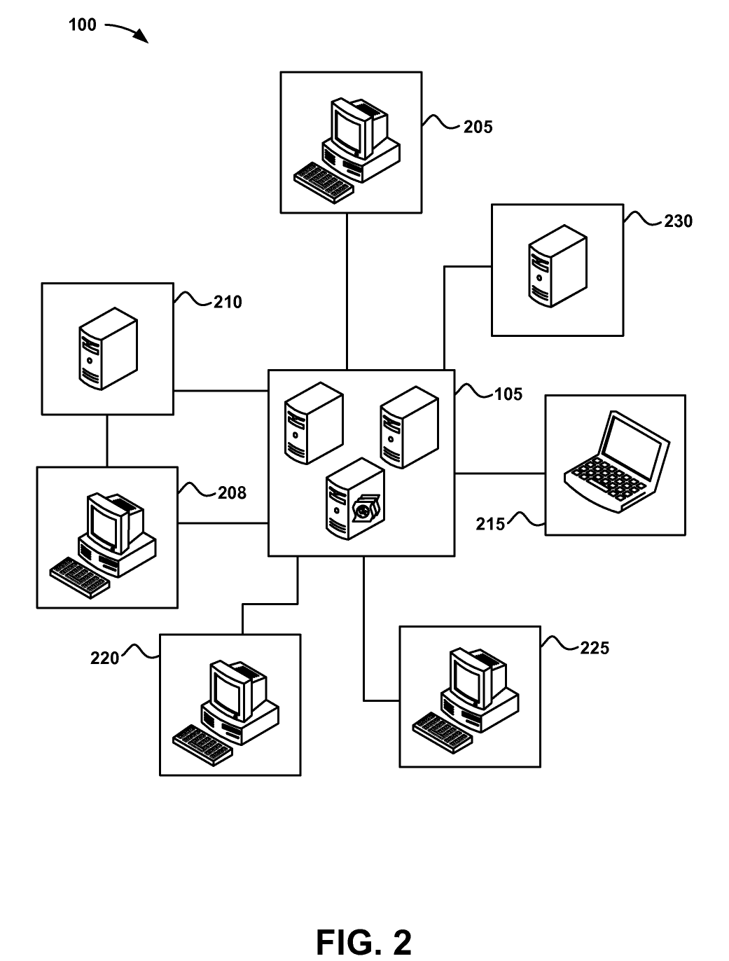

FIG. 2 shows a diagram illustrating a computer environment used in preferred embodiments of the present invention. To implement recording and transcription management system 100, recording and transcription management computer system 105 is set up and configured to serve recording and transcription management web site 145. In that regard, recording and transcription management computer system 105 preferably comprises at least one web server, at least one database server (such as an SQL server), at least one application server, at least one authentication server, etc.

Recording and transcription management computer system 105 is accessible by many user types such as at least one recording-and-transcription-management-computer-system administrator 205, at least one court 210 via at least one court-associated user 208 (e.g., court staff member(s), court clerk(s), appointed administrator(s), etc.), at least one requestor 215 (e.g., at least one attorney, litigant, journalist, member of the public, etc.), at least one transcription-agency-associated user 220 (e.g., a transcription agency staff member, an appointed administrator, etc.), and at least one typist 225, as shown.

As explained in co-owned U.S. Pat. No. 6,871,107, U.S. Pat. No. 7,212,873, and U.S. Pat. No. 7,617,445, each of which is hereby incorporated by reference in its entirety, a digital recording of a proceeding is recorded and stored on a computer system. Court 210 preferably comprises at least one computer system which stores copies of these recorded proceedings for later retrieval. The at least one computer system of court 210 is preferably communicatively coupled with recording and transcription management computer system 105, as shown.

Recording and transcription management computer system 105 is preferably managed by recording-and-transcription-management-computer-system administrator 205 who accesses recording and transcription management computer system 105 to perform administrative duties.

Additionally, recording and transcription management computer system 105 is preferably communicatively coupled with at least one eCommerce computer system 230 to manage receiving and disbursing payments made for services by requestor 215.

With reference to FIG. 1, the parties of FIG. 2 preferably communicate with recording and transcription management computer system 105 using network 110.

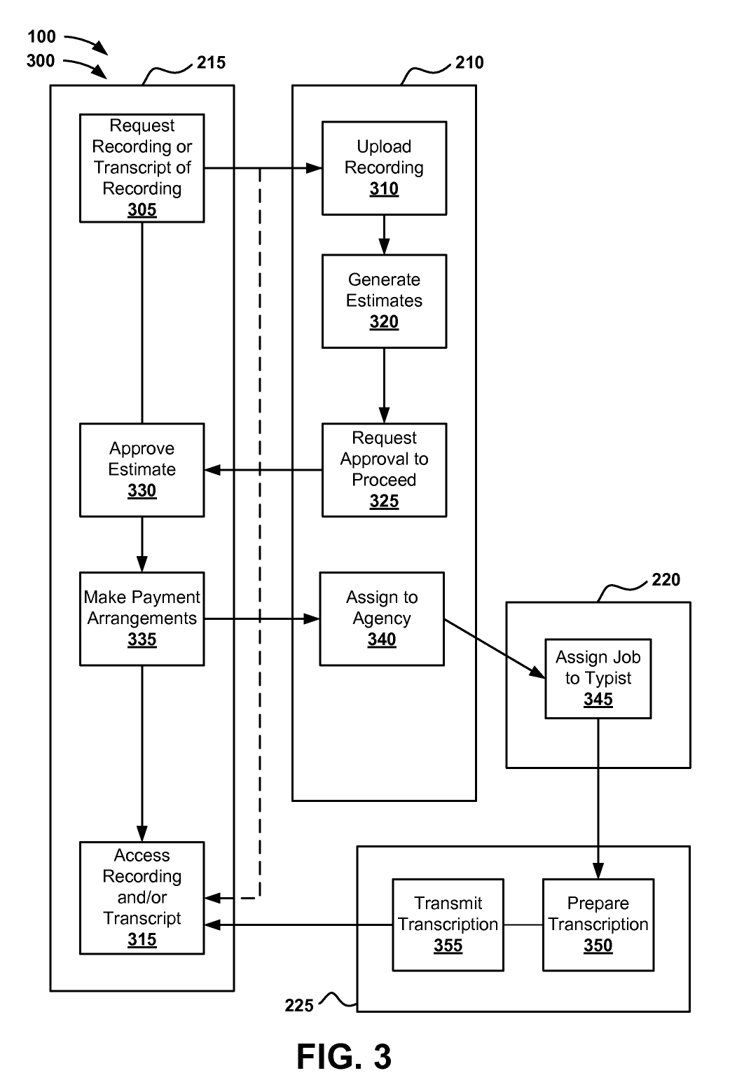

FIG. 3 shows a flowchart illustrating a method of fulfilling a request for a recording or transcript of a recording according to a preferred embodiment of the present invention.

More particularly FIG. 3 shows the interactions of requestor 215, court 210, transcription agency 220, and typist 220. Preferably, recording and transcription management system 100 comprises recording and transcription request fulfillment method 300, as shown.

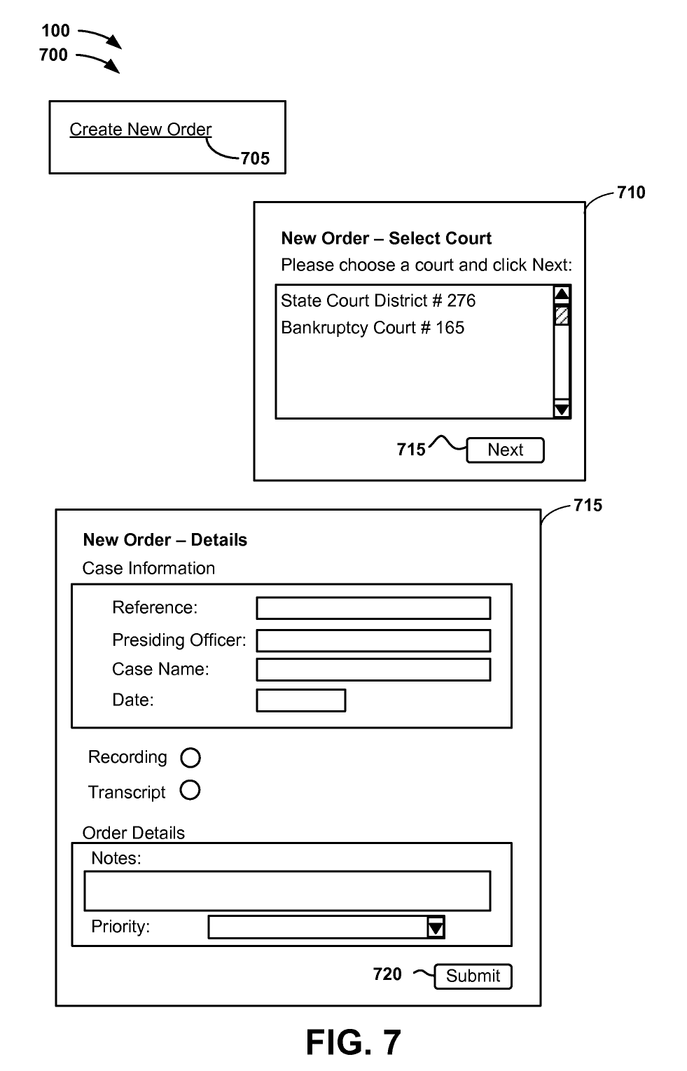

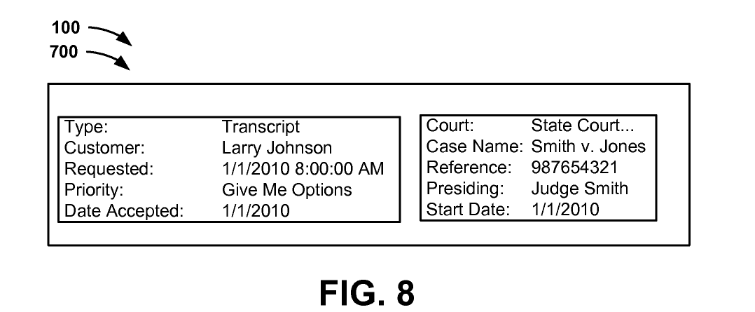

In recording and transcription request fulfillment method 300, requestor 215 accesses recording and transcription management computer system 105 (by way of recording and transcription management web site 145) and performs step request recording or transcript of recording 305 (see FIGS. 7 and 8 which illustrates the order request process). Once requested, court 210 is preferably notified of the request. Preferably, court-associated user 208 locates the requested recording and performs step upload recording 310. In step upload recording 310, one or more recordings are transferred from the court's at least one computer system to recording and transcription management computer system 105. If only a recording has been requested (and payment arrangements from requestor 215 have been made), requestor 215 is granted access to the recording in step access recording and/or transcript 315. Requestor may download and play the recording with a suitable player (such as TheRecord Player v. 5.4.1.0 made available by FTR Pty Ltd., headquartered in Western Australia). In another preferred embodiment, the recording may be played/streamed directly in a web browser accessing recording and transcription management web site 145.

If a transcript has been requested, court 210 preferably generates estimates of the cost of the transcription using recording and transcription management computer system 105 in step generate estimates 320. In step generate estimates 320, recording and transcription management computer system 105 preferably calculates one or more estimates for a transcription of one or more recordings automatically as discussed further herein.

After generating an estimate, court 210 preferably requests approval from requestor 215 to proceed with ordering of the transcript in step request approval to proceed 325. Preferably, requestor 215 provides approval (and preferably handles payment arrangement) or, if many estimates were requested, selects one estimate among two or more estimates to authorize court 210 to proceed with the transcription process. Requestor 215 preferably performs this step in approve estimate 330, as shown. Requestor 215 also preferably makes payment arrangements in step make payment arrangements 335, as shown. Under appropriate circumstances, requestor 215 may have a retainer account established in which case step make payment arrangements 335 may be automatically performed such that court 210 only needs approval of an estimate to proceed.

Once the estimate has been approved and payment arrangements have been made, court 210 preferably assigns the job of transcribing the recording to a transcription agency 220 in step assign to agency 340, as shown. Transcription agency 220 is preferably notified of the transcription job and preferably assigns the transcription job to at least one typist 225 in step assign to typist 345, as shown. Next, one or more of typist 225 preferably prepares a transcript of the recording in step prepare transcription 350. When completed, typist 225 preferably transmits the completed transcript (preferably by email to court 210 who uploads it onto recording and transcription management computer system 105 or by directly uploading the completed transcript to recording and transcription management computer system 105 preferably using recording and transcription management web site 145) to recording and transcription management computer system 105 in step transmit transcription 355, as shown. After uploading (and any payment finalization steps or intermediate steps by court 210 [which may include the requestor paying actual costs of the transcription or the court providing a refund if the estimate was higher than the actual costs incurred]), requestor 215 is granted access to the recording and completed transcript in step access recording and/or transcript 315.

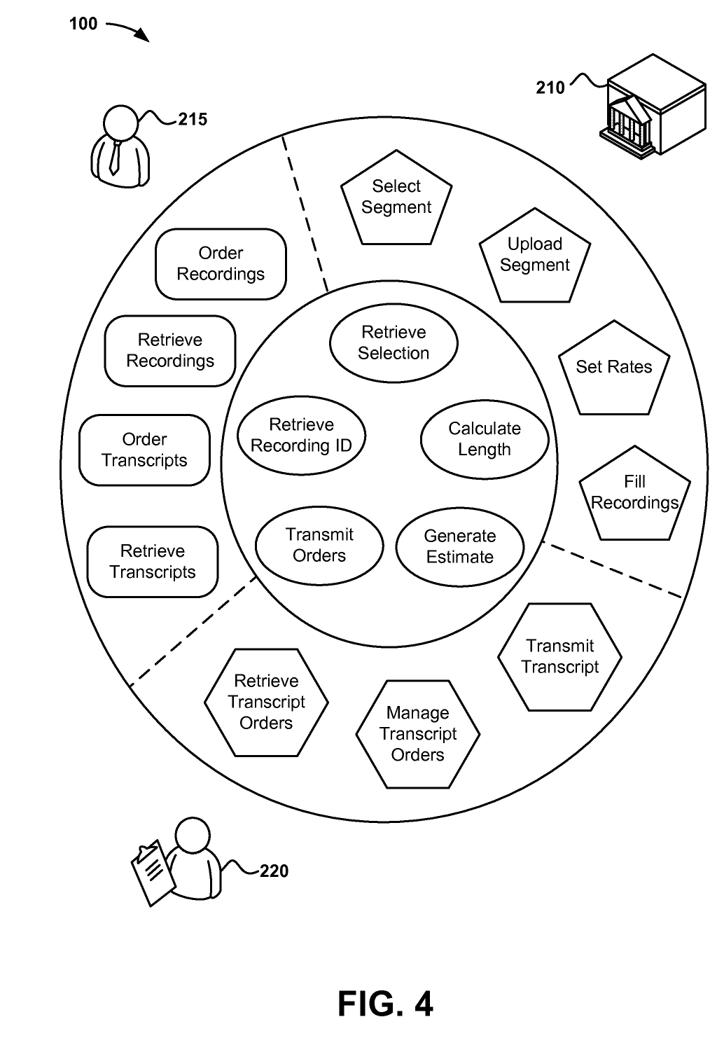

FIG. 4 shows a diagram illustrating the interactions of various user types with the computer system elements hereof. As shown requestor 215 preferably interacts with recording and transcription management computer system 105 to order and receive recordings and to order and receive transcripts, as shown. Court 210 preferably interacts with recording and transcription management computer system 105 to select recording segments (from requests made by requestor 215), upload recording segments, set rates for transcription services, and fill orders for requested recordings or transcriptions. Transcription agency 220 preferably interacts with recording and transcription management computer system 105 to retrieve transcript orders, manage transcript orders (which includes producing transcripts), and transmit transcripts. As discussed above, transcription agency 220 preferably works with one or more of typist 225 to perform the task of transcribing a recording.

Preferably, when events take place (requests, approvals, transmittals, etc.) on recording and transcription management computer system 105 or recording and transcription management web site 145, recording and transcription management computer system 105 and recording and transcription management web site 145 preferably facilitate communication between parties in various ways which may include email notifications, website notifications, text-message notifications, chat between parties, and the like.

Using recording and transcription management computer system 105, the following functions are preferably performed: retrieving recordings by identifying indicia (which may include location, date, time, bitrate, number of channels, channel labels, etc.), retrieving selections of recordings (by selecting a portion of audio in a playback device), calculating the length of a particular retrieved recording, generating an estimate of the price to create a transcript, and transmitting completed orders to the appropriate parties.

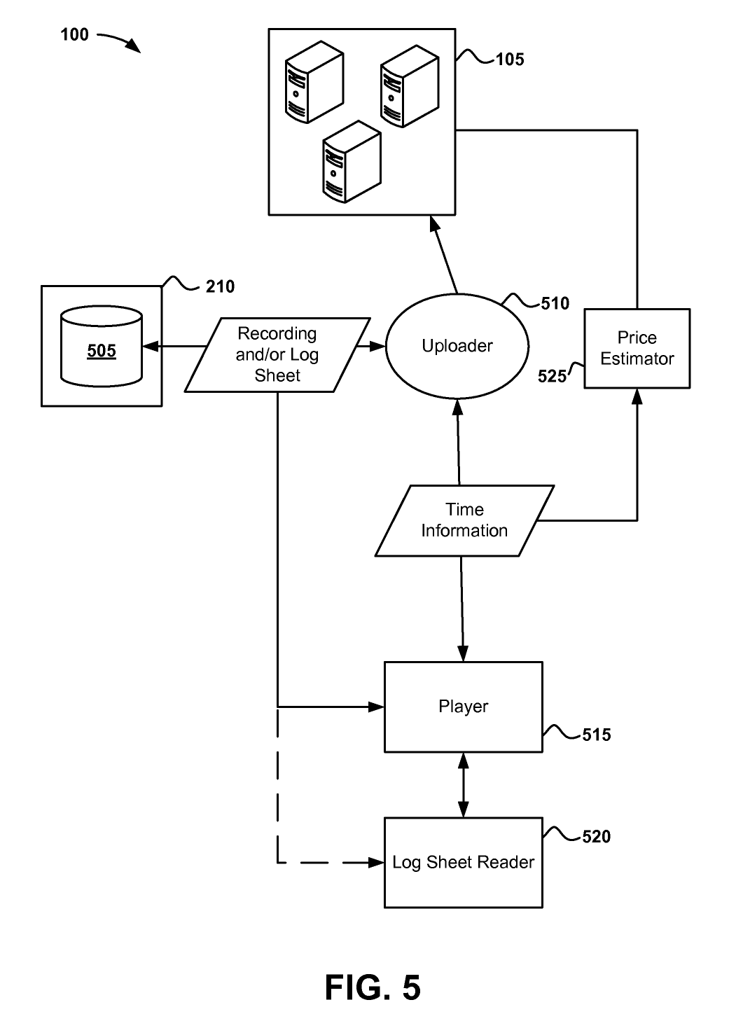

FIG. 5 shows a diagram illustrating computer interactions among various computer elements of recording and transcription management system 100.

As previously discussed, recording and transcription management system 100 preferably comprises recording and transcription management computer system 105, as shown. Recording and transcription management computer system 105 preferably serves recording and transcription management web site 145. Users preferably accesses recording and transcription management web site 145 with an Internet web browser.

When a request for a recording is received, court 210 is notified when accessing recording and transcription management computer system 105 (preferably by way of a notice on recording and transcription management web site 145). As will be shown later, requestor 215 preferably provides court 210 with identifying information so that court may retrieve the proper recording from its data storage.

Court 210 preferably views which recordings have been requested and proceeds to locate the recordings on data archive 505 of court 210. Preferably, the recordings and/or log sheets are found on data archive 505 of court 210 and a selected recording is preferably loaded into player 515 (preferably TheRecord Player made available by FTR Pty Ltd., headquartered in Western Australia). If selected, a log sheet is preferably loaded into log sheet reader 520 (preferably FTR Log Notes made available by FTR Pty Ltd., headquartered in Western Australia).

Reference will now be made to co-owned U.S. Pat. Nos. 6,871,107, 7,212,873, and 7,617,445. Log sheets contain notes entered by a user (such as a court clerk) which such entered notes are correlated to a particular recording to enable rapid and accurate access to specific portions of the recording identified by the notes. In some instances, a user may wish to have the log sheets available with the recording as it makes traversing to particular spots in the recording essentially effortless. As described in the aforementioned patents, the recording loaded into player 515 and the notes loaded in log sheet reader 520 are time-linked to one another such that selecting a particular note causes the player to jump to that time in the recording and effect playback. When a recording is loaded into player 515 (preferably “Playback Panel” in U.S. Pat. No. 7,212,873), an entire day of recording (recorded at a particular location [e.g., a courtroom]) is loaded for playback. Preferably, start and stop times within the entire day of recording may be set as described in U.S. Pat. No. 6,871,107 (see, e.g., FIG. 4 of U.S. Pat. No. 6,871,107 and its related description). Thus, preferably, a full day of recording may be selected for upload/transcription or a selected segment of the full day of recording may be selected for upload/transcription.

Once the recording has been loaded into player and the recording segment has been selected, the selected segment is preferably uploaded by uploader 510. It is noted that, under appropriate circumstances, if a full day of recording is to be uploaded, the recording files may be uploaded without loading the recording into player 515. Additionally, under appropriate circumstances, many segments of an entire day of recording may be selected and uploaded in a single step. Additionally, the entire recording may be uploaded with noted instruction as to what portions require transcription. The typist may simply play the portions noted in the instructions.

When player 515 has a loaded recording, the time information loaded into player 515 may be determined. Preferably, when a recording is made, the recording comprises a plurality of files each of a predetermined maximum length of time. Preferably, player 515 loads all of the related files for playback so that playback is effected in a chronological sense. Each file of the recording preferably has an associated time, date, and location (identifying indicia) preferably incorporated into the file name of each segment (see, e.g., U.S. Pat. No. 6,871,107, col. 4, lines 36-46). Upon reading the teachings of this specification, those of ordinary skill in the art will now understand that, under appropriate circumstances, embedding identifying indicia into the file-associated metadata, storing a separate searchable association between the identifying indicia and the files, etc., may suffice.

Because the recording segments are of predetermined length, the selected time may be determined by summing the time values of each of the files loaded into the player and selected for playback (if the entire day is selected, then all of that day's files will be summed). For those recording segments that do not take up the maximum predetermined length of time, the time of these recording segments may be determined by file size determination or by bit rate determination. Thus, for a given recording loaded into player 515 or for which a segment is selected, time information may be determined. Alternately preferably, the time of a particular recording may be determined using file size determination or bit rate determination.

Once time information has been determined, this time information may be passed onto price estimator 525 which generates one or more price estimates by computer calculation. Preferably, price estimator 525 is an interface of recording and transcription management web site 145.

Recording are preferably uploaded using uploader 510. Uploader 510 is preferably communicatively coupled with data archive 505 of court 202 and recording and transcription management computer system 105, as shown. Uploader 510 is preferably a computer application installed on the computer of the user who is performing the uploading. Preferably, when instructed to do so, uploader 510 uploads recording and/or log sheet files to recording and transcription management computer system 105. If an entire day of recording is selected, uploader 510 preferably uploads all of the files which make up day of recording. If only a portion of an entire day is selected, only those files corresponding to the portions selected are preferably uploaded. Preferably, the time information is also uploaded and stored on recording and transcription management computer system 105 in association with the uploaded recording.

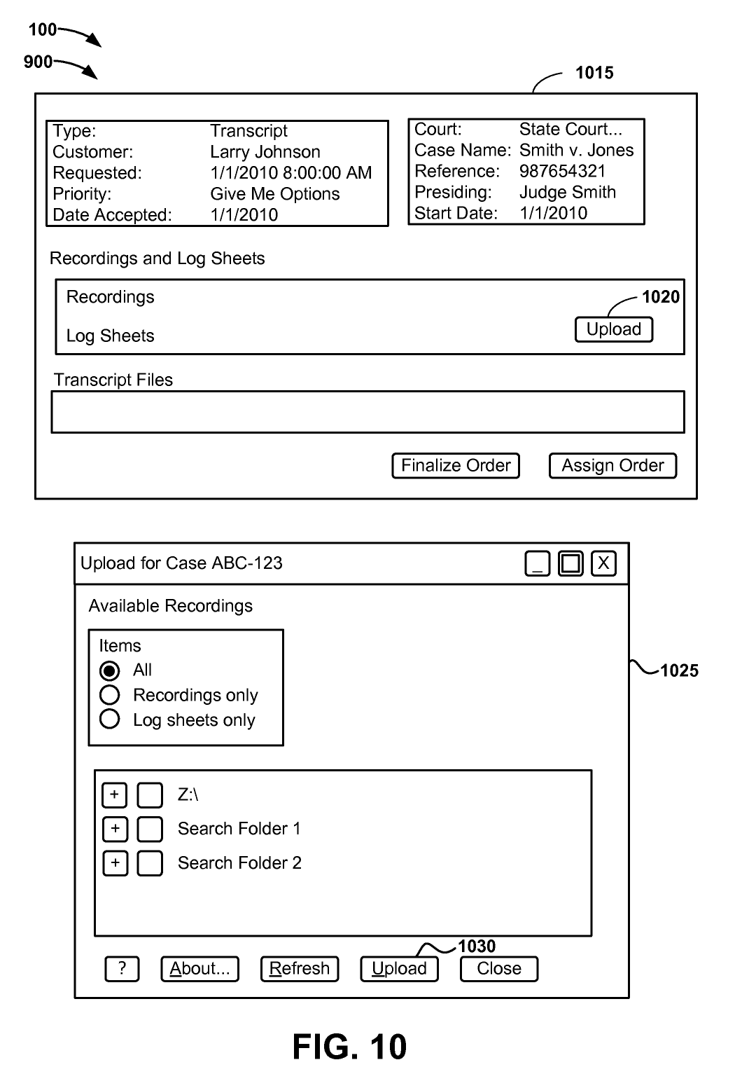

Preferably, the upload instruction comes from a user clicking on an upload button when logged in to recording and transcription management web site 145 (see, e.g., FIG. 10). Under appropriate circumstances, uploading of recordings and/or log sheets may occur automatically when requested by requestor 215 (since log sheets contain detailed information about a proceeding [at least location, date, and time, but also, for example, witness names, custom-made notes regarding specific events, etc.], the log sheet information may be parsed for matches to the information given in a requests; when a match is found, automatic uploading may occur). Upon reading the teachings of this specification, those of ordinary skill in the art will now understand that, under appropriate circumstances, using log sheet information to automate certain functions, such as automatically requesting or retrieving recordings/transcripts for testimony from a particular witness, a particular judge, etc., may suffice. Additionally, under appropriate circumstances, price estimates may be automatically generated by requestor 215 using only the determined time information without requiring upload of recordings.

Preferably, the determined time information is uploaded to recording and transcription management computer system 105 and stored in association with the uploaded recording (such determined time information to be later used by price estimator 525). Alternately preferably, the determined time information may be uploaded and stored without also needing upload of the recordings.

Preferably, court-associated user 208 initiates a transfer of the selected recording(s) from data archive 505 of court 210 to recording and transcription management computer system 105. When uploader 510 has finished uploading the recording, recording and transcription management computer system 105 will display the uploaded recordings and/or log sheets with hyperlinks to access the files. Preferably, only those entitled to access the hyperlinks are provided with such access (for example, the court clerk who uploaded the file would be entitled to access the hyperlinks, the transcription agency assigned to the transcription job, etc.). In situations where a proceeding may be “sealed”, preferably encryption of recordings, log sheets, and transcripts, use of access keys, etc., are implemented to keep the sealed case information secure.

Preferably, when an entitled court-associated user 208, entitled transcription-agency-associated user 220, etc., logs in to recording and transcription management computer system 105, theses users have access to the hyperlinks.

The following discussion and illustrations explain screen shots and user interfaces which preferably implement the systems described herein.

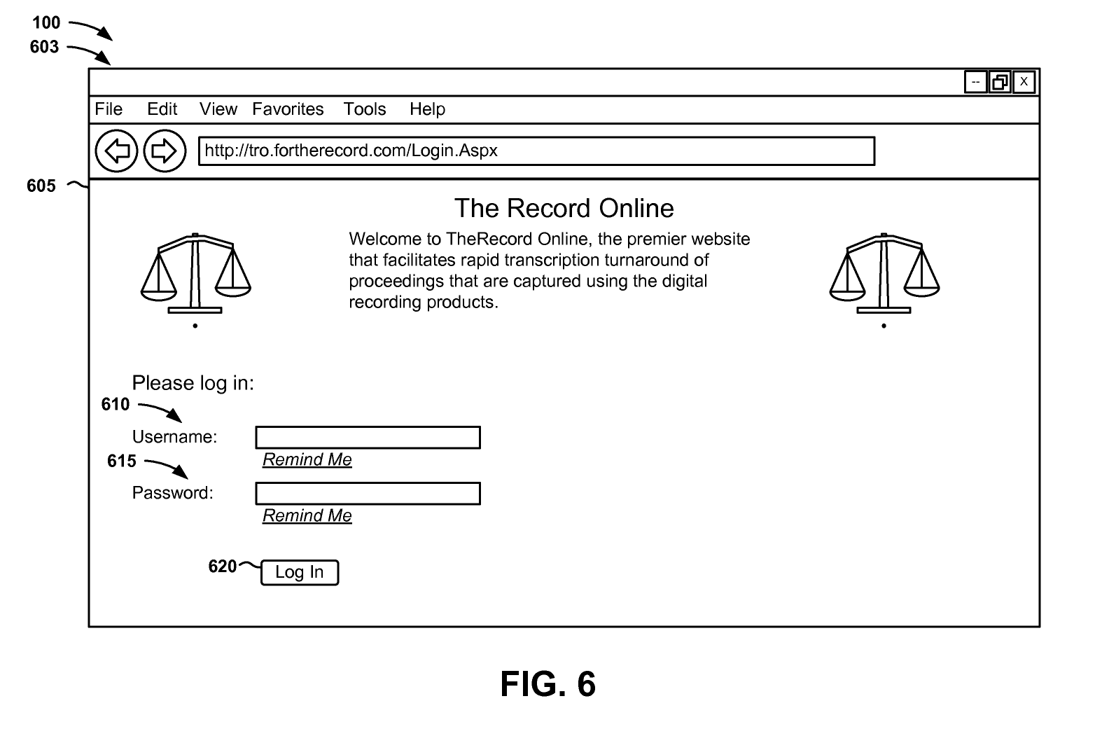

FIG. 6 shows an illustration of a log in screen of a recording and transcription management web site according to a preferred embodiment of the present invention.

Preferably, using web browser 603, requestor 215, court-associated user 208, transcription agency 220, typist 225, and recording-and-transcription-management-computer-system administrator 205 preferably access recording and transcription management web site 145 by inputting log in credentials (username 610 and password 615) into log in interface 605. After inputting credentials, the user clicks log in button 620, which gives the user access to the functions of recording and transcription management web site 145. As shown in FIG. 6, if a user forgets his or her username or password, a “remind me” hyperlink may be clicked which will initiate a username or password reminder process.

Prior to accessing recording and transcription management web site 145, users must register with recording and transcription management web site 145 which will establish log in credentials for the registering user.

For the remaining discussion, unless otherwise noted, the computer interface screens explained below are preferably displayed in web browser 603. Under appropriate circumstances, the user interfaces described herein screens may be part of a stand-alone computer application installed on one computer.

FIG. 7 shows illustrations of various computer interface screen of a recording and transcription management web site illustrating an order request process according to a preferred embodiment of the present invention.

Recording and transcription management system 100 preferably comprises recording and/or transcription request process 700, as shown. Preferably, to create a new request for a recording and/or transcription, requestor 215 logs in to recording and transcription management web site 145 (see FIG. 6). Next, using web browser 603, requestor 215 finds and clicks on create new order hyperlink 705, as shown. Preferably, several courts are registered with recording and transcription management web site 145. Next, requestor 215 preferably selects at least one court from court-selection interface 710. After selecting a court, requestor 215 clicks next button 715.

Next, requestor 215 preferably inputs more detailed information about the recording and/or transcript requested in new order details interface 720, as shown. This information preferably includes the proceeding reference (such as a case number or docket number), as shown. Additionally, the name of the presiding officer (e.g., judge) may be provided by requestor 215. Additionally, requestor 215 preferably inputs the case name (e.g., Smith vs. Brown). Additionally, requestor 215 inputs the date of the proceeding. Preferably, requestor inputs 215 identifying information into each of the listed fields to ensure that the proper recording is found by court 210 (or alternately preferably by recording and transcription computer system 100) once the request is submitted.

Next, requestor 215 indicates whether he or she requests a recording of a proceeding only or a transcript of a proceeding (preferably, if a transcript is requested, court 210 also makes the recording available to requestor 215). Next, in the “order details” portion of the new order details interface 720, requestor 215 may input notes comprising instructions for court 210 or transcription agency 220/typist 225. For example, requestor 215 may only wish a certain portion of the proceedings transcribed or made available. In the “notes” field, requestor 215 may indicate that he or she wishes a particular time range of a proceeding, testimony from a particular witness, a particular trial segment (e.g., closing arguments), etc. It is noted that if a given proceeding spans more than one day, requestor 215 may submit separate order requests for each day or input a note requesting multiple days into the details section. Under appropriate circumstances, new order details interface 720 permits requestor 215 to input or select a date range if a recording or transcription from more than one day is desired.

Regarding turn-around time, requestor 215 preferably selects a priority from among several options. For example, requestor 215 is preferably presented with monthly, weekly, daily, and hourly priority options from which to select. Additionally, requestor 215 preferably is given an option to see prices for all priorities by selecting an appropriate selection (e.g., a “Give Me Options” selection which will provide requestor 215 with two or more price estimates for a given priority).

Preferably, after providing the information described in new order details interface 720, requestor 215 clicks submit button 725 which transmits the new order/request to recording and transcription management computer system 105.

FIG. 8 shows an illustration of order request information displayed by recording and transcription management web site according to a preferred embodiment of the present invention.

After submitting a request for a new order, the new order request details are preferably displayed by recording and transcription management web site 145. Preferably, completed requests may be archived and later retrieved from recording and transcription management web site 145.

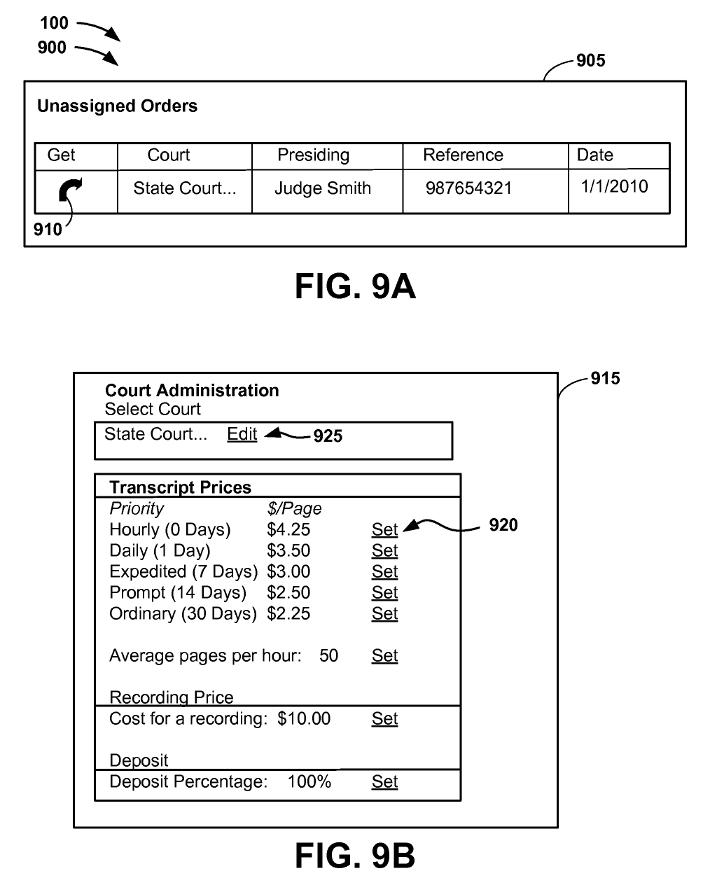

FIG. 9A shows an illustration of a portion of an order fulfillment process according to a preferred embodiment of the present invention.

Recording and transcription management system 100 preferably comprises recording and/or transcription request fulfillment process 900, as shown.

To fulfill orders, court-associated user 208 preferably logs in to recording and transcription management web site 145 (see FIG. 6). The court staff member either selects the proper court via a court selection interface (see, e.g., FIG. 7) or recording and transcription management web site 145 presents to court-associated user 208 those requests which are associated with the court that particular court-associated user 208. To do this, recording and transcription management computer system 105 preferably associates each court-associated user 208 with at least one court registered with recording and transcription management web site 145.

Preferably, court-associated user 208 accesses unassigned orders which need processing. Preferably, recording and transcription management web site 145 displays unassigned order interface 905 to court-associated user 208. To access the details of the unassigned order, court-associated user 208 preferably clicks hyperlink 910 and is preferably presented with the order details submitted by requestor 215.

FIG. 9B shows set price interface 915 of recording and transcription management web site 145 according to a preferred embodiment of the present invention. Preferably, an estimate is generated for transcription services requested by requestor 215. Each court preferably has the ability to set rates for providing access to recordings or for transcription services. Set price interface 915 preferably provides courts with an easy means of setting and modifying prices for its services. As shown, prices may be set for a particular court (different courts may have different rates for services).

As shown in FIG. 9B, the price for a transcript varies based on the requested turn-around time. Generally speaking, a transcript with a rapid turn-around time request is more expensive than one with a less demanding turn-around time. Here court-associated user 208 sets prices by clicking “set” hyperlink 920 for each value to be set or reset, entering a value into the appropriate price field, and saving the values. These saved values will be used by recording and transcription management computer system 105 to generate estimates for requestors 215.

Additionally, court-associated user 208 sets an “average pages per hour” value used to generate estimates. Some types of proceedings may, from experience, generate more content than others. For those proceedings with more content, a higher “average page per hour” value would be beneficial as it would give a more accurate estimate of the transcription work to be performed. In one preferred embodiment, court-associated user 208 may set an “average page per hour” value for each particular proceeding type. Doing so would better ensure that accurate estimates are provided minimizing the need for refunds or further payment from a request or after performing transcription work.

It is noted that the screen set price interface 915 shown in FIG. 9B further permits setting a price for providing a recording and a minimum deposit price required before providing a recording or commencing work on a transcript. Additionally, if court-associated user 208 finds that he or she is setting the values for the wrong court, court-associated user 208 simply clicks select court edit button 925 which will permit court-associated user 208 to select a different court and set prices for the newly selected court.

It is noted that, using the methods and systems hereof, a court could set a rate for providing a recording using time as a factor (rather than a fixed price for an entire day of recording). In this regard, a requestor would make a request for select portion(s) of one or more recordings and only purchase and have access to those portions necessary. This gives requestors more control over spending and provides the requestors with information that the requestor finds most useful.

FIG. 10 shows an illustration of another portion of an order fulfillment process according to a preferred embodiment of the present invention. Continuing with recording and/or transcription request fulfillment process 900, court-associated user 208 is preferably presented with order details interface 1015. Order details interface 1015 preferably displays the order details input by requestor 215.

Next, court-associated user 208 uploads recordings which correspond to the order details. The upload process is preferably initiated by clicking upload button 1020. Upon clicking upload button 1020, the computer which court-associated user 208 is operating preferably runs uploader 510 (see FIG. 5).

Preferably, upload assister interface 1025 is loaded which assists court-associated user 208 in retrieving recordings and/or log sheets from the data archive 505 of court 210 and uploading selected recording and/or log sheets to recording and transcription management computer system 105.

Preferably, upload assister interface 1025 provides a user with a graphical user interface to search for the relevant recordings and/or log sheets. Upload user interface 1025 preferably permits selection of recordings and/or log sheets, just recordings, or just log sheets. Upload user interface 1025 provides selection tools for selecting one or more files on data archive 505 of court 210. Data archive 505 of court 210 is preferably viewable by way of the “tree” directory structure shown in FIG. 10. As previously mentioned (and as discussed in U.S. Pat. No. 7,212,873) the file segments which make up each day of recording are preferably identified by location, date, and time. Preferably, files are findable on data archive 505 of court 210 by knowing the location and date when the recording took place. In this way, a user can traverse the directory structure and find the appropriate file. Thus, a user can efficiently locate recordings and/or log sheets using the interface provided by searching the data archive first by location or date. Once the desired recording(s) and/or log sheet(s) have been found, the user clicks upload button 1030 which initiates a file transfer from data archive 505 of court 210 to recording and transcription management computer system 105. Alternately preferably, a log sheet search interface (see FIG. 9 of U.S. Pat. No. 7,617,445) may be used to search for recordings instead of using the interface shown in the bottom portion of FIG. 10. Using the log sheet search interface, a user need only search for keywords in association with the log sheets. Upon finding one or more log sheets that match the keywords searched, the log sheets may be opened. Once a log sheet is opened, the corresponding file(s) of the recording are loaded into player 515 and the recording uploaded to recording and transcription management computer system 105. Upon reading the teachings of this specification, those of ordinary skill in the art will now understand that, under appropriate circumstances, other interfaces, such as an interface which combines tree directory searching and log sheet searching to locate relevant recordings, may suffice.

It is additionally preferred that court-associated user 208 have the ability to perform a word search for information which may be stored within log sheets associated with the recordings. Log sheets contain detailed information and notes about a proceeding and may contain the name of a witness, a note about the beginning of closing arguments, etc. When word searching, preferably upload assist interface 1025 would present hits which match the inputted word search. Under appropriate circumstances, the retrieval of a recording or log sheet may even be made automatic as the data archive may be parsed for the information submitted by the requestor. In this preferred embodiment, the recording and/or log sheet upload would occur automatically without intervention by court-associated user 208.

As previously mentioned with respect to FIG. 5, if a segment of a day of recording is to be uploaded, the day's recording is loaded into player 515 and the desired time range selected. Alternately preferably, log sheet reader may be used to indicate a starting note and an ending note. Making selections on the log sheet, being time linked to player 515, makes the appropriate time selections in player (see U.S. Pat. No. 7,617,445). The selected segment may then be uploaded as described above.

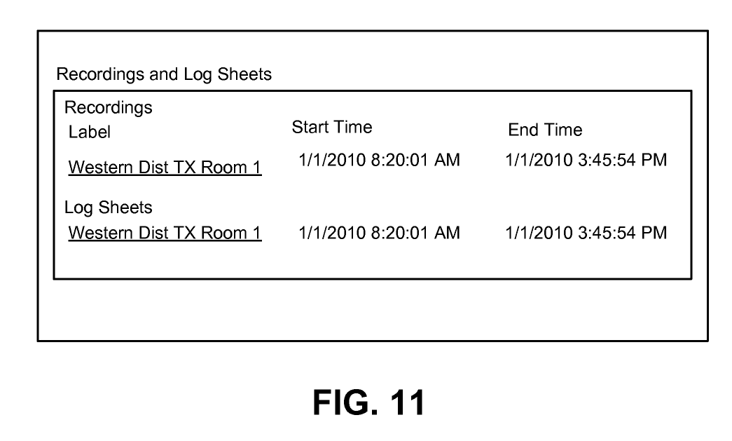

FIG. 11 shows an illustration of an interface after successful uploading of a recording or log sheet according to a preferred embodiment of the present invention.

Once the upload process has been completed, the recordings and/or log sheets are available for further use. Preferably, they are accessible as hyperlinks to entitled parties/users. When clicked, the recordings and/or log sheets may be downloaded or may be opened with a player and/or log sheet reader on the computer of the user accessing the files.

When court-associated user 208 logs in to recording and transcription management web site 145, the new order details will be available for further processing (namely, arranging transcription).

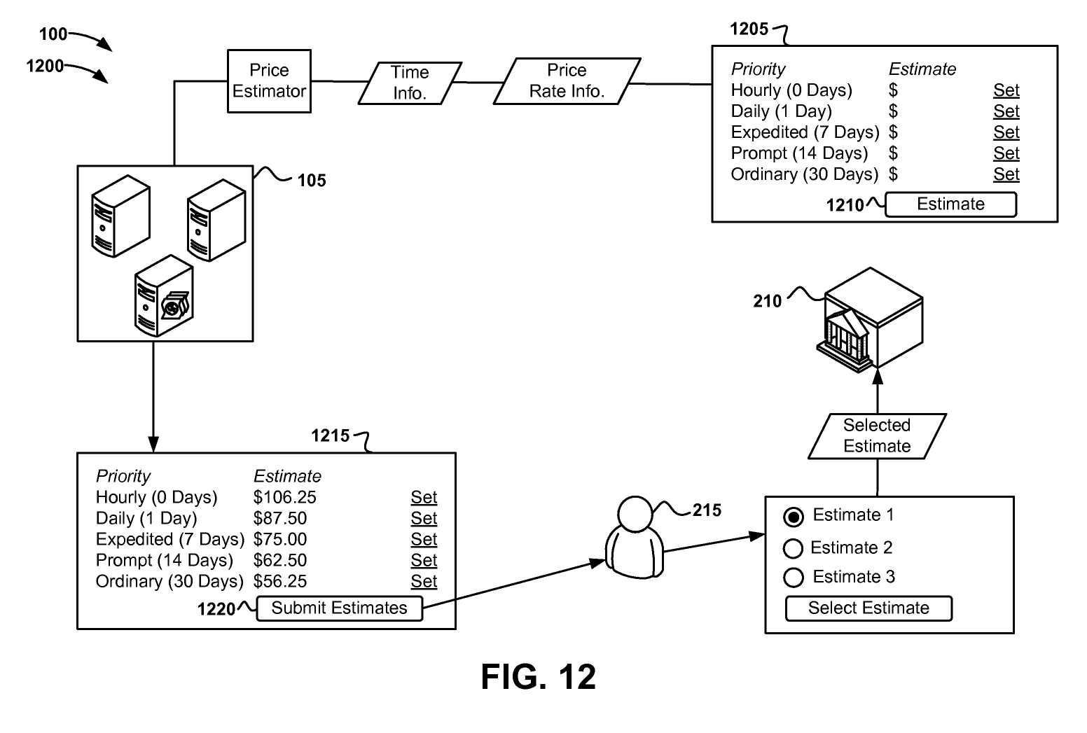

FIG. 12 shows a price estimation process for producing a transcript from a recorded proceeding according to a preferred embodiment of the present invention.

Preferably, recording and transcription management system 100 comprises estimate generation and approval process 1200, as shown.

Once the recordings and/or log sheets are available on recording and transcription management web site 145, court-associated user 208 preferably generates estimates for approval by requestor 215. With reference to FIG. 5, time information selected is preferably determined and stored on recording and transcription management computer system 105 for later use. Additionally, price rate information for each court (see FIG. 9B and its associated description) is stored by recording and transcription management computer system 105 for later use. When court-associated user 208 wishes to generate an estimate for a requestor, court-associated user 208 preferably navigates to generate estimate interface 1205 and clicks estimate button 1210. Preferably, recording and transcription management computer system 105 calculates the product of the time information for a particular recording, preferably the court-set page rate for a given priority (turn-around time) and the court-set “average page per hour” value. It is noted that with the determined time information, any formula for determining an estimate of transcription services may be used to generate the price estimate. Upon reading the teachings of this specification, those of ordinary skill in the art will now understand that, under appropriate circumstances, other factors in determining a rate for transcription services, such as, price per word, average number of words per hour, price per character, average number of keystrokes, etc., may suffice.

When calculated, the generated result is displayed in estimate results interface 1215. Court-associated user 208 then preferably submit estimates button 1220 which sends the generated estimates to requestor 215 for approval. If only one estimate was requested, requestor 215 is presented with that estimate and either rejects the estimate or accepts the estimate and makes payment arrangements. If multiple estimates were requested, requestor is presented with estimates for each priority in select estimate interface 1225, as shown. Requestor 215 preferably selects a desired estimate and communicates its selection to court 210 by clicking select estimate button 1230, as shown. The selected estimate information is preferably displayed by recording and transcription management web site 145 to court 210 for further processing.

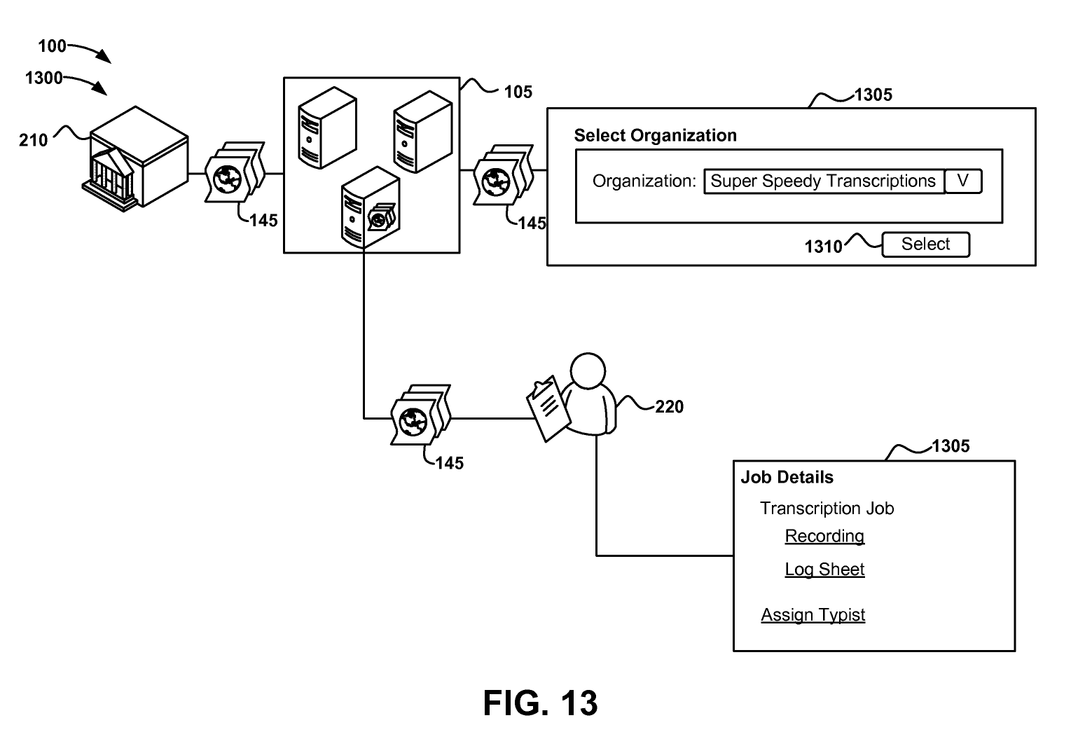

FIG. 13 shows an assign transcription agency process according to a preferred embodiment of the present invention.

Preferably, recording and transcription management system 100 comprises assign transcription job process 1300, as shown.

Once court 210 receives approval from requestor 215, court 210 may assign a transcription job to a transcription agency. Preferably court uses select agency interface 1305 to select a transcription agency. Preferably, recording and transcription management computer system 105 stores an association between transcription agencies and courts that maintain a business relationship. As discussed above, recording and transcription management computer system 105 stores an association between court and court-associated user. Preferably, only those transcription agencies associated with the associated court of a court-associated user are presented for selection. Court-associated user 208 preferably selects a transcription agency and clicks select button 1310. The selection is received by recording and transcription management computer system 105 which associates the transcription job with a transcription agency. When transcription-agency-associated user 220 logs in to recording and transcription management web site 145 (see FIG. 6), the job details (including access to the recording and any related log sheets) are displayed in job details interface 1305. To assign a typist, transcription-agency-associated user 220 navigates to an assign typist interface.

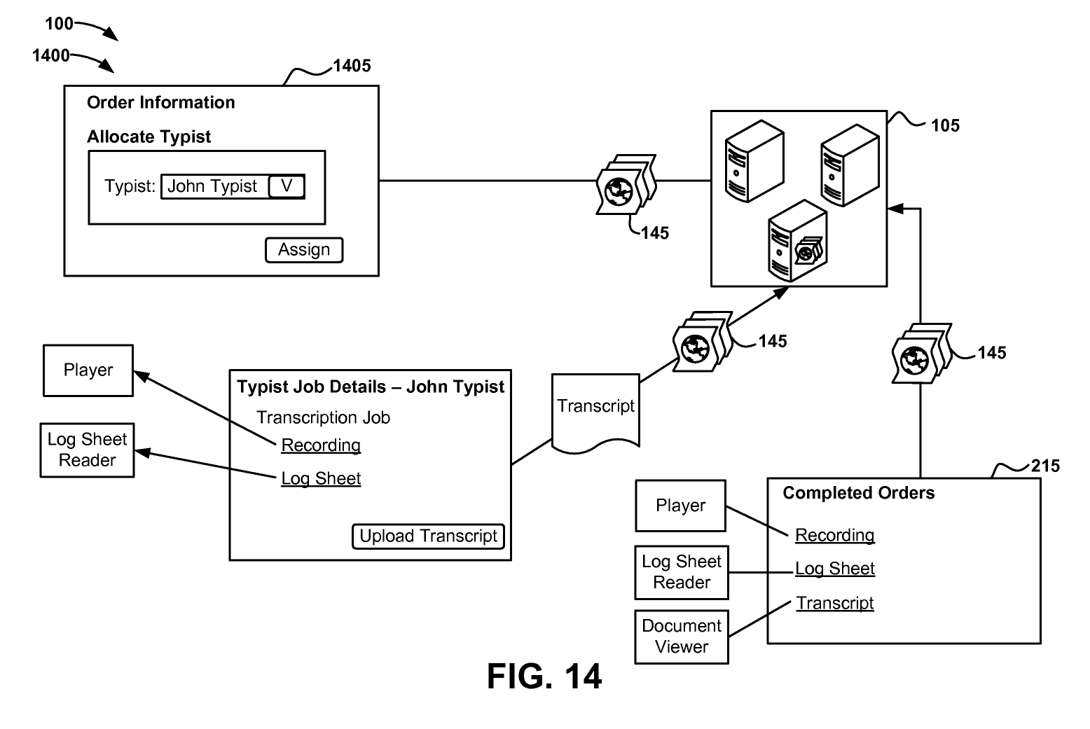

FIG. 14 shows an assign typist process according to a preferred embodiment of the present invention.

Preferably, recording and transcription management system 100 comprises assign typist job process 1400, as shown.

To assign a typist to a particular job, transcription-agency-associated user 220 logs in to recording and transcription management web site 145 and navigates to assign typist interface 1405. Preferably, recording and transcription management computer system 105 stores an association between each typist and their affiliated transcription agency. Preferably, assign typist interface 1405 only displays for selection those typists associated with the transcription agency. Preferably one or more typists may be assigned to perform the transcription. Additionally, transcription-agency-associated user 220 may provide instructions for the typist (apart from the order details submitted by requestor 215).

After selecting at least one typist, transcription-agency-associated user 220 clicks assign button 1410. This selection is transmitted to recording and transcription management computer system 105. When typist logs in to recording and transcription management web site 145 and navigates to his or her available jobs, the typist job details will be displayed, as shown. Preferably, a hyperlink to the recording and log sheets are available. Clicking on the recording hyperlink preferably loads a suitable player for playback of the recording. The typist plays the recorded signals and produces a text transcript of the recorded signals. Additionally, the typist may click on the log sheet hyperlink which will load the log sheet into the log sheet reader. The recordings and log sheets may also be downloaded onto the hard drive of the typist's computer prior to loading the audio into the player or opening the log sheet in the log sheet reader. This is beneficial in that the typist does not need to stay in communication with recording and transcription management web site 145. The typist preferably has the option to work “offline”.

The typist preferably types the text of the recording into a word processor. Once the transcription is complete, the typist may transmit the completed transcript to the typist's transcription agency manager by email or use a preferred upload transcript feature of recording and transcription management web site 145. After transmitting the completed transcript, the transcription agency and court will be notified that the job has been completed.

Under appropriate circumstances, time stamps may be preferably embedded in the completed transcript. Preferably, the time stamps correspond to the time of the recording on which the transcript is based. The time stamp information may be stored by recording and transcription management computer system 105 and associated with other identifying information. Future requests for transcripts may be compared to the stored information. If a match is found, the transcript need not be re-transcribed and a discounted rate may be offered to a requestor for access to the transcript.

After transcription is completed, the actual production costs of the transcription service are determined. The transcription job is preferably finalized, and the requestor will pay the difference between the estimate and the actual cost (if the actual costs are higher than the estimate) or receive a refund. Once any payment issues have been attended to, requestor 215 is granted access to the transcript (as well as optionally to the related recording(s) and log sheet(s)). The transcript is preferably viewable in a document viewer.

It is noted that the transcription duty may be allocated to one or more typists by the transcription agency. If this is done, the transcription agency must merge the documents created by the multiple typists prior to making the transcript available to the requestor.

Preferably, to monitor progress of one or more typists, the computer which a typist operates is preferably communicatively coupled to recording and transcription management computer system 105. Preferably, typist loads the recording to be transcribed into a suitable player and begins playback of the recording to be transcribed. Preferably a polling agent periodically polls the player to determine the playback time and preferably the total time which is being transcribed (to determine a percent complete value). The polled time information is preferably stored by recording and transcription management computer system 105 and made available to a manager to monitor status of a transcription job.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A computer-implemented method, relating to transcription generation from at least one recorded proceeding, said method comprising the steps of:
a) determining, by at least one computer, elapsed time of at least one recorded proceeding;
b) retrieving, by at least one computer, stored rate information for transcription generation; and
c) generating, by at least one computer, at least one price estimate to generate at least one transcript of the at least one recorded proceeding by calculating the product of the determined elapsed time and the stored rate information.

2) The computer-implemented method according to claim 1 further comprising the step of displaying at least one generated price estimate for approval by at least one requestor.

3) The computer-implemented method according to claim 2 further comprising the step of receiving requestor approval to produce at least one transcript of the at least one recorded proceeding.

4) The computer-implemented method according to claim 3 further comprising the step of providing requestor access to the at least one produced transcript.

5) The computer-implemented method according to claim 1 wherein, prior to determining, by at least one computer, elapsed time of at least one recorded proceeding, at least one portion of the recorded proceeding is selected.

6) The computer-implemented method according to claim 1 wherein at least one recorded proceeding is loaded into at least one recording playback device and such at least one recording playback device permits selection of at least one start time and at least one end time from which elapsed time of the selected timeline may be determined by at least one computer.

7) The computer-implemented method according to claim 1 wherein the stored rate information for transcription generation includes at least one price per page and at least one average page per hour rate.

8) A computer-implemented method, relating to transcription generation from at least one recorded proceeding, said method comprising the steps of:
a) receiving at least one request for at least one transcript of at least one recorded proceeding;
b) receiving at least one copy of the at least one recorded proceeding;
c) generating at least one price estimate for transcription preparation of the at least recorded proceeding;
d) receiving approval to prepare at least one transcript;
e) receiving at least one completed transcript.

9) The computer-implemented method according to claim 8 further comprising the step of receiving at least one computer-assisted selection of at least one transcription agency to manage transcript preparation.

10) The computer-implemented method according to claim 8 further comprising the step of receiving at least one computer-assisted selection assisting selection of at least one typist to perform transcript preparation.

11) The computer-implemented method according to claim 8 further comprising receiving at least one log sheet associated with the at least one recorded proceeding.

12) The computer-implemented method according to claim 8 wherein the at least one recorded proceeding is found and selected from a plurality of recorded proceedings using at least one interface to assist finding a particular recorded proceeding recorded at a particular location.

13) The computer-implemented method according to claim 8 wherein the at least one recorded proceeding is found and selected from a plurality of recorded proceedings using at least one interface to assist finding a particular recorded proceeding recorded on a particular date.

14) The computer-implemented method according to claim 8 wherein the at least one recorded proceeding is found and selected from a plurality of recorded proceedings using at least one interface to assist finding a particular recorded proceeding recorded at a particular time.

15) The computer-implemented method according to claim 8 further comprising the step of providing access to at least one entitled user to at least one recording and at least one generated transcript corresponding to the at least one recording.

16) The computer-implemented method according to claim 8 further comprising the step of providing access to at least one entitled user to at least one recording, at least one corresponding log sheet, and at least one generated transcript corresponding to the at least one recording.

17) The computer-implemented method according to claim 8 wherein the at least one recorded proceeding is found and selected from a plurality of recorded proceedings using at least one interface to assist finding particular information corresponding to information found in at least one log sheet.

18) The computer-implemented method according to claim 8 further comprising receiving time information corresponding to the time of the recorded proceeding.

19) The computer-implemented method according to claim 18 wherein the time information is used to generate the at least one price estimate for transcription preparation of the at least recorded proceeding.

20) A computer-implemented method, relating to transcription generation from at least one recorded proceeding, said method comprising the steps of:
a) determining, by at least one computer, elapsed time of at least one recorded proceeding;
b) retrieving, by at least one computer, stored rate information for transcription generation; and
c) generating, by at least one computer, at least one price estimate to generate at least one transcript of the at least one recorded proceeding by calculating the product of the determined elapsed time and the stored rate information.
